(19) United States
(12) Patent Application Publication
(10) Pub. No.: US 2013/0323665 A1
(43) Pub. Date: Dec. 5, 2013

(54) ORTHODONTIC ALIGNERS, METHODS OF USING SUCH ALIGNERS, AND ADDITIVE MANUFACTURING METHODS AND APPARATUS FOR MAKING AND USING SUCH ALIGNERS

(71) Applicants: Paul D. Dinh, Houston, TX (US); Jarrett J. Pumphrey, Houston, TX (US); Henry A Bowling, Newbury Park, CA (US)

(72) Inventors: Paul D. Dinh, Houston, TX (US); Jarrett J. Pumphrey, Houston, TX (US); Henry A Bowling, Newbury Park, CA (US)

(21) Appl. No.: 13/488,450

(22) Filed: Jun. 5, 2012

(51) Int. Cl. A61C 7/08

(52) U.S. Cl. CPC A61C 7/08
USPC 433/6; 433/24; 427/2.29

(57) ABSTRACT

A system for repositioning teeth comprises a plurality of individual appliances. The appliances are configured to be placed successively on the patient's teeth and to incrementally reposition the teeth from an initial tooth arrangement, through a plurality of intermediate tooth arrangements, and to a final tooth arrangement. The appliances comprise at least 200 layers.

### RELATED APPLICATION DATA

Not applicable.

### BACKGROUND OF THE INVENTION

1. Field of the Invention

The present invention relates orthodontic apparatus and methods, and methods of making and using such orthodontic apparatus. In another aspect, the present invention relates to apparatus and methods for incrementally moving teeth, and to methods of making and using same. In another aspect, the present invention relates to orthodontic apparatus, methods of using such apparatus, additive manufacturing methods and apparatus for making such orthodontic apparatus, and to methods of making and using same. In even another aspect, the present invention relates to orthodontic aligners, methods of using such aligners, and to 3D printing methods and apparatus for making such aligners.

2. Brief Description of the Related Art

Traditionally, repositioning teeth for aesthetic or other reasons was generally accomplished by wearing what are commonly referred to as “braces”, which were typically metal orthodontic appliances affixed to the teeth and adjusted from time to time to reposition teeth. These metal-type braces generally include a small bracket that is glued to the front of each tooth and the molars are adjusted with a band that encircles the tooth.

These metal-type braces suffer from a number of disadvantages, including not being easily removable, limitations on the type of food that may be eaten, the required periodically tightening/adjustment by an orthodontist, and a certain unappealing look.

A very popular alternative to metal-type braces are progressive, removable aligners that may be used to gradually move teeth into their final positions.

U.S. Pat. No. 5,975,893 issued Nov. 2, 1999, U.S. Pat. No. 6,217,325 issued Apr. 17, 2001, and U.S. Pat. No. 6,398,548 issued Jun. 4, 2002, all to Chishti et al., disclose a system for repositioning teeth that comprises a plurality of individual appliances. The appliances are configured to be placed successively on the patient's teeth and to incrementally reposition the teeth from an initial tooth arrangement, through a plurality of intermediate tooth arrangements, and to a final tooth arrangement. Each individual appliance will be configured so that its tooth-receiving cavity has a geometry corresponding to an intermediate or end tooth arrangement intended for that appliance. That is, when an appliance is first worn by the patient, certain of the teeth will be misaligned relative to an undeformed geometry of the appliance cavity. Systems according to Chisti et al. will include at least a first appliance having a geometry selected to reposition a patient's teeth from the initial tooth arrangement to a first intermediate arrangement where individual teeth will be incrementally repositioned. The system will further comprise at least one intermediate appliance having a geometry selective to progressively reposition teeth from the first intermediate arrangement to one or more successive intermediate arrangements. The system will still further comprise a final appliance having a geometry selected to progressively reposition teeth from the last intermediate arrangement to the desired final tooth arrangement. In some cases, it will be desirable to form the final appliance or several appliances to “over correct” the final tooth position.

Very commonly, these aligners are manufactured as follows. First, a record of the patient's teeth is obtained, using any of a number of methods including the traditional impression method, x-rays, digital imaging, and the like. A series of actual 3D or digital models are then made of the initial tooth position, final desired tooth position, and intermediate tooth positions. From these models, the aligners are then obtained. In one common method, actual 3D models of the tooth positions are obtained, and the aligners are vacuum formed over the models. In another common method, the digital models are utilized as guides to sculpt the aligners from a block of material.

Additive manufacturing is defined by ASTM as the “process of joining materials to make objects from 3D model data, usually layer upon layer, as opposed to subtractive manufacturing methodologies, such as traditional machining.” Additive technology may also be referred to as additive fabrication, additive processes, additive techniques, additive layer manufacturing, layer manufacturing and freeform fabrication.

3D printing is a form of additive manufacturing technology where a three dimensional object is created by laying down successive layers of material. 3D printers are generally faster, more affordable and easier to use than other additive manufacturing technologies. 3D printers offer product developers the ability to print parts and assemblies made of several materials with different mechanical and physical properties in a single build process. Advanced 3D printing technologies yield models that closely emulate the look, feel and functionality of product prototypes.

A 3D printer works by taking a 3D computer file and using and making a series of cross-sectional slices. Each slice is then printed one on top of the other to create the 3D object.

For a number of years, there has been large growth in the sale of 3D printers. Additionally, the cost of 3D printers has declined. The technology also finds use in the jewelry, footwear, industrial design, architecture, engineering and construction, automotive, aerospace, dental and medical industries.

U.S. Pat. No. 6,554,613, issued Apr. 29, 2003, and U.S. Pat. No. 6,918,761, issued Jul. 19, 2005 both to Sachdeva, et al., discloses a method and apparatus for generating an orthodontic template that assists in placement of orthodontic apparatus, and includes processing that begins by obtaining a digital model of an orthodontic structure of an orthodontic patient. The processing continues by obtaining a selection of one of a plurality of orthodontic apparatuses for the orthodontic structure to produce a selected orthodontic apparatus. The processing then continues by obtaining a digital model of placement of the selected orthodontic apparatus on the digital model of the orthodontic structure. The processing then continues by retrieving a digital image of a tooth mounting apparatus (e.g., a bracket, a band, a headgear tube, etc.) of the selected apparatus for a given tooth. The processing then continues by generating a orthodontic template for holding a physical embodiment of the tooth mounting apparatus based on the digital image of the tooth mounting apparatus, the digital model of the placement, and at least a portion of the digital model of the orthodontic structure. It is also disclosed that once the orthodontic template is designed, it may be fabricated using 3D printing.

U.S. Pat. No. 7,077,646, issued Jul. 18, 2006, to Hilliard discloses a method for producing orthodontic aligners uses a CAD system to modify a digital model of the patient's oral anatomy to incorporate features that accommodate attachment of aligner auxiliaries to the completed aligner(s). It is also discloses that the using rapid prototyping machines, physical models are grown using one of a group of known processes generally called stereo lithography or 3D printing.

U.S. Pat. No. 7,124,067, issued Oct. 17, 2006, to Ascenzi, discloses a structural and mechanical model and modeling methods for human bone based on bone's hierarchical structure and on its hierarchical mechanical behavior. The model allows for the assessment of bone deformations, computation of strains and stresses due to the specific forces acting on bone during function, and contemplates forces that do or do not cause viscous effects and forces that cause either elastic or plastic bone deformations. Ascenzi discloses that material analogs of bone can be obtained by means of 3D printers.

U.S. Pat. No. 7,160,110, issued Jan. 9, 2007, to Imgrund, et al., discloses three-dimensional occlusal and interproximal contact detection and display using virtual tooth models. It is also disclosed that a 3D model of a crown can be exported to a rapid prototyping machine (such as, for example, stereolithography (SLA), laser 3D printing, etc.) for manufacture of a physical model of the crown.

U.S. Patent Application No. 20080050692, published Feb. 28, 2008, by Hilliard, discloses a system and method for fabricating orthodontic aligners. The present invention is directed to a method of fabricating a successive set of patterns representing incremental stages of an orthodontic treatment plan, and then sending all or a portion of the successive patterns at the same time to the dentist. The dentist is provided with a vacuum machine for thermoforming a set of aligners as negative impressions of the positive teeth patterns. The successive patterns may be obtained by 3D printing technology.

U.S. Pat. No. 7,686,989, issued Mar. 30, 2010, to Van der Zel, discloses a method for manufacturing a dental restoration, including: determining an external form and dimensions available for a completed restoration; obtaining an image of a natural tooth to be replaced with the restoration or a tooth corresponding therewith, wherein the image comprises at least the external surface visible in use of the to be replaced or corresponding tooth, with variations in the appearance therein; defining locally on and at least to visible depth below the surface of appearance-determining properties of at least one material to be applied for the restoration in accordance with the obtained image and the variations in the appearance therein; constructing the restoration, including the steps of: providing at least one material to be applied in non-cohesive form; and providing cohesion to the material in accordance with the available form and dimensions. As disclosed, a 3D printer is used to apply an organic binder whereby complex shapes can be produced.

U.S. Pat. No. 7,708,557, issued May 4, 2010, to Rubbert, discloses a dental prosthesis for periodontal integration is disclosed. Furthermore a customized dental prosthesis for osseointegration is disclosed having a first manufactured portion shaped to substantially conform to the three-dimensional surface of a root of a tooth to be replaced and a second manufactured portion shaped to substantially conform to the three-dimensional surface of a crown of a tooth to be replaced. Furthermore a customized manufactured splint is disclosed to position and fixate a tooth-shaped prosthesis. Furthermore a CAD/CAM based method of and a system for manufacturing a customized dental prosthesis replacing an extracted tooth is disclosed, where the extracted tooth is scanned regarding its three-dimensional shape and substantially copied using (a) an imaging system in-vitro like a 3D scanner or in-vivo like a cone beam CT system, (b) CNC machinery and (c) biocompatible material that is suitable to be integrated into the extraction socket and at least partially adopted by the existing tissue forming the socket. Discloses that 3D printing may be utilized to fabricate a substantial copy of the original tooth.

U.S. Pat. No. 7,726,968, issued Jun. 1, 2010, to Raby, et al., discloses bonding trays for orthodontic treatment are made from a model of the patient's dental arch that is manufactured using digital data and rapid prototyping processes. The model includes one or more guides for orienting an orthodontic appliance in a desired position on a model tooth of the dental arch model. A holder is connected to the archwire slot of the appliance and is brought into contact with the guide in order to move the appliance to its intended position for subsequent manufacture of the indirect bonding tray.

U.S. Pat. No. 7,735,542, issued Jun. 15, 2010, to Marshall, et al., discloses dental appliances including multiple components and a system and method for constructing the same. The dental components are designed to fit together to form the dental appliance. The components of the dental appliance are electronically modeled, printed, and pressed sequentially, separately, or as a unitary piece. Forming the dental appliance from multiple components enables each component of the dental appliance to be formed from a different material, each material having different features associated with it. In various embodiments, different materials have different colors, textures, opacities, and transformation factors associated with them. Furthermore, each component can be formed from multiple components. In some other embodiments, a support structure is designed and constructed in order to minimize deformation of a dental component during fabrication of the component. Further discloses that a model of a coping or crown may be rapid prototyped directly using 3D printing.

U.S. Pat. No. 7,792,341, issued Sep. 7, 2010, to Schutyser, discloses a method for performing a cephalometric or anthropometric analysis comprising the steps of: acquiring a 3D scan of a person's head using a 3D medical image modality, generating a 3D surface model using data from the 3D scan, generating from the 3D scan at least one 2D cephalogram geometrically linked to the 3D surface model, indicating anatomical landmarks on the at least one 2D cephalogram and/or on the 3D surface model, performing the analysis using the anatomical landmarks. Discloses that using 3D printing, the splints are directly produced or otherwise a model is produced from which a splint can be derived manually by routinely used techniques.

U.S. Patent Application No. 20110020761, published Jan. 27, 2011, by Kalili, discloses an orthodontic repositioning appliance, wherein 3D printing may be utilized for making the model on which the associated appliance is vacuum formed.

While 3D printing has been utilized in the dental art in the making of a number of dental apparatus, including the making of models on which aligners are vacuum formed, there has not been any teaching or suggestion to directly make aligners by directly 3D printing the aligners.

All of the patents, applications and publications cited in this specification, are herein incorporated by reference.

However, in spite of the above advancements, there still exists a need in the art for additional methods and apparatus for repositioning teeth.

There is another need in the art for aligners made by directly 3D printing the aligners.

This and other needs in the art will become apparent to those of skill in the art upon review of this specification, including its drawings and claims.

### SUMMARY OF THE INVENTION

It is an object of the present invention to provide for apparatus and methods for improved methods and apparatus for repositioning teeth.

It is another object of the present invention to provide for aligners made by directly 3D printing the aligners.

This and other objects of the present invention will become apparent to those of skill in the art upon review of this specification, including its drawings and claims.

According to one non-limiting embodiment of the present invention, there is provided a system for repositioning teeth progressively through N number of tooth arrangements, from an initial tooth arrangement designated arrangement 1, through at least one intermediate tooth arrangement designated arrangements 2 through N−1, and then to a final tooth arrangement designated arrangement N. The system may comprise a sequential series of N−1 number of dental incremental position adjustment appliances, wherein each i^{th} appliance has a geometry selected to reposition the teeth from the i^{th} arrangement to the (i+1)^{th} arrangement, wherein the appliances comprise polymeric shells having cavities, wherein the cavities of successive shells have different geometries shaped to receive and resiliently reposition teeth from the i^{th} arrangement to the (i+1)^{th} arrangement, and wherein the polymeric shells comprise at least 200 layers.

According to another non-limiting embodiment of the present invention, there is provided a method for repositioning teeth progressively through N number of tooth arrangements, from an initial tooth arrangement designated arrangement 1, through at least one intermediate tooth arrangement designated arrangements 2 through N−1, and then to a final tooth arrangement designated arrangement N, utilizing a system for repositioning teeth. The system may comprise a sequential series of N−1 number of dental incremental position adjustment appliances, wherein each i^{th} appliance has a geometry selected to reposition the teeth from the i^{th} arrangement to the (i+1)^{th} arrangement, wherein the appliances comprise polymeric shells having cavities, wherein the cavities of successive shells have different geometries shaped to receive and resiliently reposition teeth from the i^{th} arrangement to the (i+1)^{th} arrangement, and wherein the polymeric shells comprise at least 200 layers, the method comprising successively placing the appliances 1 through N−1 in a patient's mouth.

According to even another non-limiting embodiment of the present invention, there is provided a method for making a system for repositioning teeth progressively through N number of tooth arrangements, from an initial tooth arrangement designated arrangement 1, through at least one intermediate tooth arrangement designated arrangements 2 through N−1, and then to a final tooth arrangement designated arrangement N. The system may comprise a sequential series of N−1 number of dental incremental position adjustment appliances, wherein each i^{th} appliance has a geometry selected to reposition the teeth from the i^{th} arrangement to the (i+1)^{th} arrangement, wherein the appliances comprise polymeric shells having cavities, wherein the cavities of successive shells have different geometries shaped to receive and resiliently reposition teeth from the i^{th} arrangement to the (i+1)^{th} arrangement, and wherein the polymeric shells comprise at least 200 layers. The method may comprise creating at least one of the appliances by depositing a first layer of the appliance on a substrate, and then sequentially depositing layers upon the first layer, with the first layer directly in contact with the substrate, and each successive layer after the first layer indirectly supported by the substrate and directly supported by the immediately preceding layer.

Further subembodiments of any of the above embodiments may include: wherein at least two of the layers are relatively parallel; wherein at least two of the layers are not parallel to each other; wherein at least two of the layers are of equal thickness; wherein a first layer has a first thickness and a second layer has a second thickness; wherein at least one of the layers has a non-uniform thickness; wherein at least one of the layers comprises at least 2 different materials; and wherein a first layer comprises a first material and a second layer comprises a second material, wherein the first and second materials are different.

These and other embodiments of the present invention are provided in this patent specification.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIGS. 1A-1E are schematic representations of a portion of an orthodontic aligner 100 showing the 3D printing of said orthodontic aligner 100 having layers 101 onto a substrate 50. FIG. 1A shows printing of an initial layer 101. FIGS. 1B and 1C show printing of additional layers 101. FIG. 1D shows the completion of the aligner 100 with a multiplicity of parallel layers 101. FIG. 1E shows an isometric schematic representation of aligner 100.

FIG. 2 is a schematic representation of a portion of an orthodontic aligner 100 having parallel layers of different thickness, specifically, parallel layers 101A of the same thickness, and layers 101B and C of different thickness.

FIG. 3 is a schematic representation of a portion of an orthodontic aligner 100 having layers of varying thickness within the layer, specifically, 101E and 101F having varying thickness within the layer. Layer 101D is a uniform thickness layer.

FIG. 4 is a schematic representation of a portion of an orthodontic aligner 100 having non-homogenous layer 101 K having section 101G of a first material, section 101H of a second material, and section 101L of a third material.

FIG. 5 is a schematic representation of a portion of an orthodontic aligner 100 having layers of different materials, specifically layer 101 M having a first material, and 101N of a second material.

### DETAILED DESCRIPTION OF THE INVENTION

In some non-limiting embodiments of the practice of the present invention, a treatment plan may be determined for a patient progressing from the initial tooth arrangement, through intermediate tooth arrangements, to a final tooth arrangement. It should be understood, that sometimes, a treatment plan is divided up into a number of smaller treatment plans, each having its own initial, intermediate and final tooth arrangements. It should also be understood that some treatment plans may have only an initial and final tooth arrangement.

In the practice of the present invention, the patient will have a first office visit during which the initial tooth position is recorded, by either taking physical impressions by capturing an image of the initial position, which can be by scanning, x-ray, photography, and the like.

A series of appliances will be created based on the initial tooth position and a desired final tooth position. The series of appliances may include an introductory appliance of the series is one that conforms to the initial tooth position, and thus comprises tooth-receiving geometry corresponding to the initial tooth position. In other words, when this introductory appliance is initially worn by the patient, none of the teeth should be misaligned relative to an undeformed geometry of the appliance cavity.

The remaining appliances of the series are designed to incrementally reposition the teeth from an initial tooth arrangement, through a plurality of intermediate tooth arrangements (if there are any), and to a final tooth arrangement.

These remaining appliances of the series are configured to be placed successively on the patient's teeth and to incrementally reposition the teeth from the initial tooth arrangement, through a plurality of intermediate tooth arrangements (if any), and to a final tooth arrangement. Each individual remaining appliance will be configured so that its tooth-receiving cavity has a geometry corresponding to an intermediate or end tooth arrangement intended for that appliance. That is, when any of the remaining appliances is first worn by the patient, certain of the teeth will be misaligned relative to an undeformed geometry of the appliance cavity.

Thus, systems according to the present invention, may include an introductory appliance having a geometry corresponding to the initial tooth position and providing no repositioning of the teeth, and remaining appliances selected to reposition a patient's teeth from the initial tooth arrangement to a first intermediate arrangement where individual teeth will be incrementally repositioned. The system will further comprise at least one intermediate appliance having a geometry selected to progressively reposition teeth from the first intermediate arrangement to one or more successive intermediate arrangements. The system will still further comprise a final appliance having a geometry selected to progressively reposition teeth from the last intermediate arrangement to the desired final tooth arrangement. In some cases, it will be desirable to form the final appliance or several appliances to “over correct” the final tooth position.

Methods and apparatus for determining the final tooth positions, and the intermediate tooth positions are well known to those of skill in the art, and any suitable ones may be utilized in the practice of the present invention.

Methods and apparatus for manufacturing a set of aligners is likewise will be well known to those of skill in the art, and any suitable ones may be utilized in the practice of the present invention.

The apparatus and methods of the present invention will now be discussed by reference to the following FIGS. 1-5.

Referring now to FIGS. 1A-1D, there are shown schematic representations of a portion of an orthodontic aligner 100 showing the 3D printing of said orthodontic aligner 100 having layers 101 onto a substrate 50. The aligner 100 is later removed from substrate 50. FIG. 1A shows printing of an initial layer 101. FIGS. 1B and 1C show printing of additional layers 101. FIG. 1D shows the completion of the aligner 100 with a multiplicity of parallel layers 101.

In the present invention, some embodiments of the orthodontic aligners may have at least 25, 50, 100, 150, 200, 250, 300, 350, 400, 450, 500, 550, 600, 750 or even 1000 layers. In other embodiments the orthodontic aligners may have at least 50 and less than 100, 150, 200, 250, 300, 350, 400, 450, 500, 550, 600, 750, 1000, 5000, or 10000 layers. As even another non-limiting example, the number of layers will generally range from/to or between any two of the following: 25, 50, 100, 150, 200, 250, 300, 350, 400, 450, 500, 550, 600, 750, 1000, 5000, or 10000 layers.

These minimum and maximum thickness of the layers will generally be determined by the 3D printing machine utilized. As a non-limiting example, for some embodiments, the thickness of the layer may be at least 0.001, 0.005, 0.01, 0.03, 0.05, 0.07, 0.1, 0.2, 0.3, 0.5, or 1 inches. As another non-limiting example, for other embodiments, the thickness of the layer may be less than 0.001, 0.005, 0.01, 0.03, 0.05, 0.07, 0.1, 0.2, 0.3, 0.5, 1, or 2 inches. As even another non-limiting example, the thickness of the layers will generally range from/to or between any two of the following: 0.001, 0.005, 0.01, 0.03, 0.05, 0.07, 0.1, 0.2, 0.3, 0.5, 1, and 2 inches.

In some embodiments of the present invention, the aligners will comprise a multiplicity of generally parallel, uniform thickness layers, same-thickness layers.

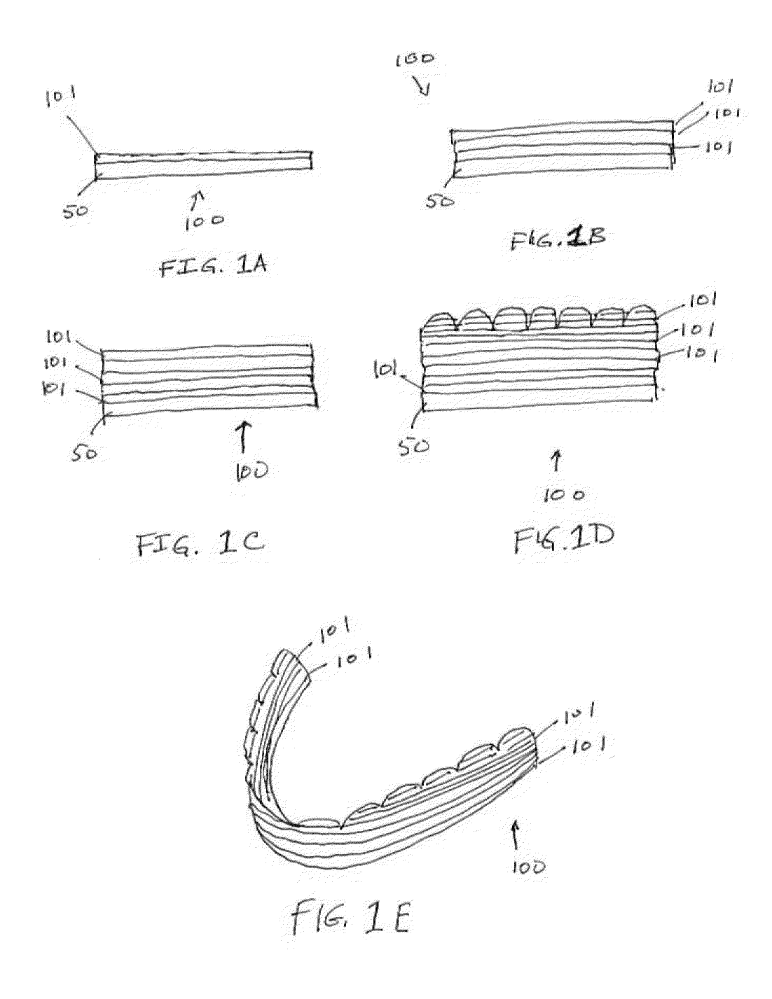

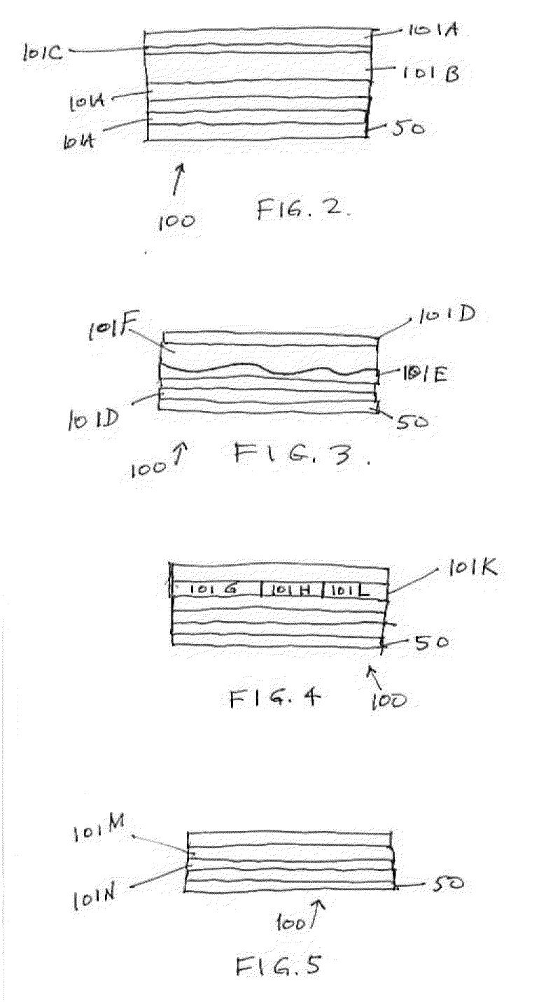

Referring additionally to FIG. 2, there is shown a schematic representation of a portion of an orthodontic aligner 100 having parallel layers of different thickness, specifically, parallel layers 101 A of the same thickness, and layers 101B and 101C of different thickness.

In some embodiments of the present invention, the aligners may comprise a layer having a thickness different than another layer. In other embodiments, the aligners may comprise parallel layers having a thickness different than other parallel layers.

Referring additionally to FIG. 3, there is shown a schematic representation of a portion of an orthodontic aligner 100 having layers of varying thickness within the layer, specifically, 101E and 101F having varying thickness within the layer. Layer 101D is a uniform thickness layer.

Some embodiments of the present invention, have at least one layer of a non-uniform thickness within the layer. In other embodiments, a layer may have a uniform thickness on one cross-section, and a non-uniform thickness in another cross-section. In even other embodiments, a layer may have non-uniform thickness in all cross-sections.

Referring additionally to FIG. 4, there is shown a schematic representation of a portion of an orthodontic aligner 100 having non-homogenous layer 101K having section 101G of a first material, section 101G of a second material, and section 101L of a third material.

In some embodiments, the aligner may comprise a layer that is non-homogenous within that layer. The non-homogeneity may be with respect to materials of construction, physical property, color, pattern, density, or any other desired design feature, property, or material.

Referring additionally to FIG. 5, there is shown a schematic representation of a portion of an orthodontic aligner 100 having layers of different materials, specifically layer 101M having a first material, and 101N of a second material.

Any suitable materials may be utilized in the 3D printing process. Suitable materials may be selected from among polycarbonates, polyacetates, polyolefins, polyamides, polystyrenes and epoxy resins among others also may be provided in clear or non-clear forms.

### EXAMPLE

An aligner was produced using an Objet EDEN500V machine as follows.

The aligner material used was Veropent Full Cure 670 available from Objet Geometries Ltd, which comprises various acrylates and a photoinitiator. The support material utilized was Full Cure 705 also available form Objet Geometries, and comprises polyethylene glycol, 1,2-propylene glycol and glycerin. The aligner was about 14 mm in height and comprised layers about 0.03 mm thick. Printing time was approximately 25 minutes.

It should be understood that the various physical components of the present invention may be well known to those of skill in the art. The patentability of the apparatus of the present invention does not reside in the patentablity of any single piece of equipment, but rather in the unique and nonobvious arrangement of the various equipment to form the overall apparatus or portion of the apparatus. Likewise, individual process steps may be generally known to those of skill in the art. The patentability of the process of the present invention does not reside in the patentablity of any single process step, but rather in the unique and nonobvious arrangement of the various process steps to form the overall process or a portion of the process.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

1. A system for repositioning teeth progressively through N number of tooth arrangements, from an initial tooth arrangement designated arrangement 1, through at least one intermediate tooth arrangement designated arrangements 2 through N−1, and then to a final tooth arrangement designated arrangement N, the system comprising a sequential series of N−1 number of dental incremental position adjustment appliances, wherein each i^{th} appliance has a geometry selected to reposition the teeth from the i^{th} arrangement to the (i+1)^{th} arrangement, wherein the appliances comprise polymeric shells having cavities, wherein the cavities of successive shells have different geometries shaped to receive and resiliently reposition teeth from the i^{th} arrangement to the (i+1)^{th} arrangement, and wherein the polymeric shells comprise at least 200 layers.

2. The system of claim 1, wherein at least two of the layers are relatively parallel.

3. The system of claim 1, wherein at least two of the layers are not parallel to each other.

4. The system of claim 1, wherein at least two of the layers are of equal thickness.

5. The system of claim 1, wherein a first layer has a first thickness and a second layer has a second thickness.

6. The system of claim 1, wherein at least one of the layers has a non-uniform thickness.

7. The system of claim 1, wherein at least one of the layers comprises at least 2 different materials.

8. The system of claim 1, wherein a first layer comprises a first material and a second layer comprises a second material, wherein the first and second materials are different.

9. A method for repositioning teeth progressively through N number of tooth arrangements, from an initial tooth arrangement designated arrangement 1, through at least one intermediate tooth arrangement designated arrangements 2 through N−1, and then to a final tooth arrangement designated arrangement N, utilizing a system for repositioning teeth, the system comprising a sequential series of N−1 number of dental incremental position adjustment appliances, wherein each i^{th} appliance has a geometry selected to reposition the teeth from the i^{th} arrangement to the (i+1)^{th} arrangement, wherein the appliances comprise polymeric shells having cavities, wherein the cavities of successive shells have different geometries shaped to receive and resiliently reposition teeth from the i^{th} arrangement to the (i+1)^{th} arrangement, and wherein the polymeric shells comprise at least 200 layers, the method comprising successively placing the appliances 1 through N−1 in a patient's mouth.

10. The system of claim 1, wherein at least two of the layers are relatively parallel.

11. The system of claim 1, wherein at least two of the layers are not parallel to each other.

12. The system of claim 1, wherein at least two of the layers are of equal thickness.

13. The system of claim 1, wherein a first layer has a first thickness and a second layer has a second thickness.

14. The system of claim 1, wherein at least one of the layers has a non-uniform thickness.

15. The system of claim 1, wherein at least one of the layers comprises at least 2 different materials.
The system of claim 1, wherein a first layer comprises a first material and a second layer comprises a second material, wherein the first and second materials are different.

16. A method for making a system for repositioning teeth progressively through N number of tooth arrangements, from an initial tooth arrangement designated arrangement 1, through at least one intermediate tooth arrangement designated arrangements 2 through N−1, and then to a final tooth arrangement designated arrangement N, the system comprising a sequential series of N−1 number of dental incremental position adjustment appliances, wherein each i^{th} appliance has a geometry selected to reposition the teeth from the i^{th} arrangement to the (i+1)^{th} arrangement, wherein the appliances comprise polymeric shells having cavities, wherein the cavities of successive shells have different geometries shaped to receive and resiliently reposition teeth from the i^{th} arrangement to the (i+1)^{th} arrangement, and wherein the polymeric shells comprise at least 200 layers, the method comprising creating at least one of the appliances by depositing a first layer of the appliance on a substrate, and then sequentially depositing layers upon the first layer, with the first layer directly in contact with the substrate, and each successive layer after the first layer indirectly supported by the substrate and directly supported by the immediately preceding layer.
